(19) United States
(12) Patent Application Publication
(10) Pub. No.: US 2023/0041142 A1
(43) Pub. Date: Feb. 9, 2023

(54) Theoretical reserve evaluation method for ocean current energy

(71) Applicant: FIRST INSTITUTE OF OCEANOGRAPHY, NATURAL RESOURCES MINISTRY, Qingdao, Shandong (CN)

(72) Inventors: Congbo Xiong, Qingdao, Shandong (CN); Wanjun Zhang, Qingdao, Shandong (CN); Dongliang Wang, Yantai, Shandong (CN); Shantao Wang, Yantai, Shandong (CN); Yanling Liu, Qingdao, Shandong (CN); Wenming Zhang, Lianyungang, Jiangsu (CN); Wanqing Chi, Qingdao, Shandong (CN); Xia Li, Qingdao, Shandong (CN); Yongqiang Zhang, Qingdao, Shandong (CN); Shuhua Bian, Qingdao, Shandong (CN); Zegao Yin, Qingdao, Shandong (CN); Yuning Chi, Manzhouli, Inner Mongolia (CN); Hongkai Zhao, Yichang, Hubei (CN); Jianqiang Liu, Qingdao, Shandong (CN); Nana Yue, Qingdao, Shandong (CN); Linhua Hao, Qingdao, Shandong (CN)

(21) Appl. No.: 17/789,209

(22) PCT Filed: Oct. 14, 2021
(86) PCT No.: PCT/CN2021/123814

§ 371 Date: Jun. 26, 2022

(30) Foreign Application Priority Data
Nov. 19, 2020 (CN) 202011304613.6

(51) Int. Cl. G06F 30/28; G01P 5/00

(52) U.S. Cl. CPC G06F 30/28; G01P 5/00; G06F 2113/08

(57) ABSTRACT

A theoretical reserve evaluation method for ocean current energy includes steps of: 1) selecting a target region, and extracting a coordinate range of the target region; 2) obtaining a seabed water depth of the target region; 3) obtaining hydrological data of flow velocities and seawater densities of a target region space; 4) calculating a theoretical reserve of the ocean current energy per unit area of the target region according to the hydrological data, 5) calculating an area of the target region; and 6) calculating the theoretical reserves of the ocean current energy within a spatial range of the target region according to the hydrological data of the flow velocities and the seawater densities obtained in the step 3), the seabed water depth of the target region obtained in the step 2), and the area of the target region obtained in the step 5).

### BACKGROUND OF THE PRESENT INVENTION

### Field of Invention

The present invention relates to a technical field of renewable energy evaluation, and more particularly to a theoretical reserve evaluation method for ocean current energy.

### Description of Related Arts

Coastal countries, especially Belgium, the United Kingdom, the United States, Russia, Japan, and France, have put great emphasis on the development of ocean energy, and have conducted in-depth research on tidal energy. Roger H. Charlier demonstrated the development prospects of tidal energy, and proposed the energy density formulas of ocean tidal energy and ocean current energy, and introduced the sea areas and the types of tidal generators with good development prospects for tidal energy. The tidal energy is similar to the ocean current energy. A. S. Bahaj and L. E. Myers compared the development of the tidal energy with that of the ocean current energy, discussed the influence of the marine environment on the tidal energy converter, and calculated the horizontal thrust of the tidal current on a cyclone-shaped wind turbine converter under common conditions. A. S. Bahaj et al. applied the tidal current data of the Alderney channel published by the British Navy to discuss the development prospect of the turbulent strait current energy in Alderney, and proposed a calculation method for daily, weekly and annual power flow energy density according to the similar characteristics of tidal current and wind. A. S. Bahaj et al. also discussed the parameters such as length, width, and height of the power flow energy converter suitable for power generation and the conversion rate of the power flow energy converter. Through the discussion of these parameters, the annual development of tidal energy in the Alderney channel was calculated, and the spatial distribution map of the tidal energy converter was given. I. G. BRYDEN et al. gave the relationship between the tidal energy conversion coefficient and the propeller rotation rate of the tidal energy converter, as well as the relationship between the flow rate and the tidal energy output rate, and discussed the geographical factors such as the water depth required by the tidal energy converter, as well as the geological conditions and the cost accounting of equipment investment. The simplified mathematical form of flow velocity was given for simulated flow in the Berneray Sound, Outer Hebrides. The reserves and scale of tidal energy in Europe were briefly described and the possible technical conditions were briefly demonstrated. W. E. Alnaser estimated the tidal energy reserves and exploitable production in the waters near Bahrain by giving the ocean current energy density formula. L. Myers et al. analyzed the flow rate reduction caused by the spacing of the tidal current energy converter units, and finely evaluated the development and utilization of tidal energy by discussing the tidal flow velocity attenuation law between generator sets in the Alderney waterway under the condition of different water resistance coefficients during spring tide. I. G. Bryden et al. studied the energy reserve device of the tidal energy converter in detail. In general, in-depth and detailed research has been conducted on the calculation of tidal current energy reserves, the calculation of developable and utilizable quantities, the spatial layout of tidal current energy converters, and the transportation and reserve of tidal current energy after converted into electrical energy.

In general, the conventional theoretical reserve evaluation method for ocean current energy is defective. In addition, the commonly used evaluation method for ocean current energy is based on the concept of kinetic energy, that is, ocean current power capacity W=½ρV³ or ocean current power density P=½ρV³A, both of which are based on kinetic energy. The latter formula is derived from the former formula, by multiplying the former formula by the area. The kinetic energy condition satisfied by the former formula is that the flow velocity must be perpendicular to the area, so the ocean current energy density can be used to calculate the spatial distribution of the ocean current energy density. However, it is rather difficult to calculate the regional ocean current energy reserve with this method.

Therefore, the present invention provides a novel theoretical reserve evaluation method for ocean current energy, which can be used for evaluating the theoretical reserve of ocean current energy in a target region.

### SUMMARY OF THE PRESENT INVENTION

The technical problem to be solved by the present invention is: to overcome the deficiencies of the prior art and provide a novel theoretical reserve evaluation method for ocean current energy. Such a method can be used to calculate the theoretical reserves of the ocean current energy in a target region according to velocity and seawater density data, and to calculate the theoretical reserves of the ocean current energy per unit area in the target region according to a calculation formula for theoretical reserve distribution of the ocean current energy per the unit area. By combining a calculation formula for theoretical reserves of regional ocean current energy, the theoretical reserves of the regional ocean current energy can be calculated, thereby evaluating ocean current energy resources.

Accordingly, to solve the above problem, the present invention provides: a theoretical reserve evaluation method for ocean current energy, comprising steps of:

1) selecting a target region for theoretical reserve evaluation of the ocean current energy, and extracting a coordinate range of the target region;

wherein the coordinate range of the target region is a sequence of longitudes and latitudes of boundary inflection points, or a description of spatial geometric scales by using a coordinate point as a reference;

2) obtaining a seabed water depth of the target region selected in the step 1);

3) obtaining hydrological data of flow velocities and seawater densities of a target region space obtained in the step 2);

wherein the hydrological data of the flow velocities and the seawater densities are measured data at one or more discrete points, or calculated data at one or more discrete points according to a numerical simulation model;

after the hydrological data of the flow velocities and the seawater densities at multiple discrete points are obtained, the target region is divided into grids; a maximum grid step size is less than or equal to 1/10 of a distance from a nearest data point; the hydrological data of the flow velocities and the seawater densities of the discrete points, together with water depth data, are interpolated to grid center points;

4) calculating a theoretical reserve of the ocean current energy per unit area of the target region according to the hydrological data obtained in the step 3);

5) calculating an area of the target region;

wherein the area of the target region is calculated based on an equal-area projection, a geometric figure area calculation method, or a polygon area calculation method, or based on AutoCAD, ArcGis, MapGis, and Mapinfor geographic information systems; and

6) calculating the theoretical reserves of the ocean current energy within a spatial range of the target region according to the hydrological data of the flow velocities and the seawater densities obtained in the step 3), the seabed water depth of the target region obtained in the step 2), and the area of the target region obtained in the step 5).

According to the theoretical reserve evaluation method for the ocean current energy, in the step 4), the theoretical reserve of the ocean current energy per unit area is calculated with the following formula:

E_{D}=∫(½ρV²)dz

wherein: E_{D} is the theoretical reserve of the ocean current energy per unit area, V is the flow velocity, ρ is the seawater density, and dz is a height of vertical space.

According to the theoretical reserve evaluation method for the ocean current energy, in the step 6), the theoretical reserves of the ocean current energy within the spatial range of the target region are calculated according to a regional ocean current energy theoretical reserve calculating formula;

the regional ocean current energy theoretical reserve calculating formula is:

E_{R}=∫∫∫(½ρV²)dxdydz

wherein: E_{R} is a regional ocean current energy theoretical reserve, V is a height-related flow velocity; ρ is the seawater density; dz is a step size of a vertical space, which is determined according to a vertical distribution of the hydrological data; ∫∫dxdy is the area of the target region selected for the theoretical reserve evaluation of the ocean current energy; dxdy is a space step size, which is determined by a plane location of the hydrological data and a meteorological complexity of the target region.

Compared with the prior art, the present invention has the following beneficial effects: 1) a novel method for calculating the theoretical reserve distribution of the ocean current energy per unit area is provided; 2) a novel method for evaluating the theoretical reserves of regional ocean current energy is provided; 3) a quantitative evaluation method for the theoretical reserves of regional ocean current energy, quantitative indicators of ocean current energy power generation resources formulated by regional or national ocean current energy policies, as well as comparison and selection of ocean current energy power generation sites are provided; and 4) the present invention has a good prospect of popularization and application, and is of great significance for developing and utilizing ocean current energy resources and formulating ocean current energy policies.

### BRIEF DESCRIPTION OF THE DRAWINGS

FIG. 1 is a basic flow chart of a theoretical reserve evaluation method for ocean current energy according to an embodiment of the present invention;

FIG. 2 is a sketch diagram of selecting a target region according to the embodiment of the present invention;

FIG. 3 illustrates water depth distribution within a selected target region according to the embodiment of the present invention;

FIG. 4 illustrates flow velocity data distribution according to the embodiment of the present invention;

FIG. 5 is a grid diagram of target region division according to the embodiment of the present invention; and

FIG. 6 is a distribution diagram of the theoretical reserve of ocean current energy per unit area according to the embodiment of the present invention.

### DETAILED DESCRIPTION OF THE PREFERRED EMBODIMENT

Referring to the drawings, the present invention will be further illustrated.

### Embodiment 1

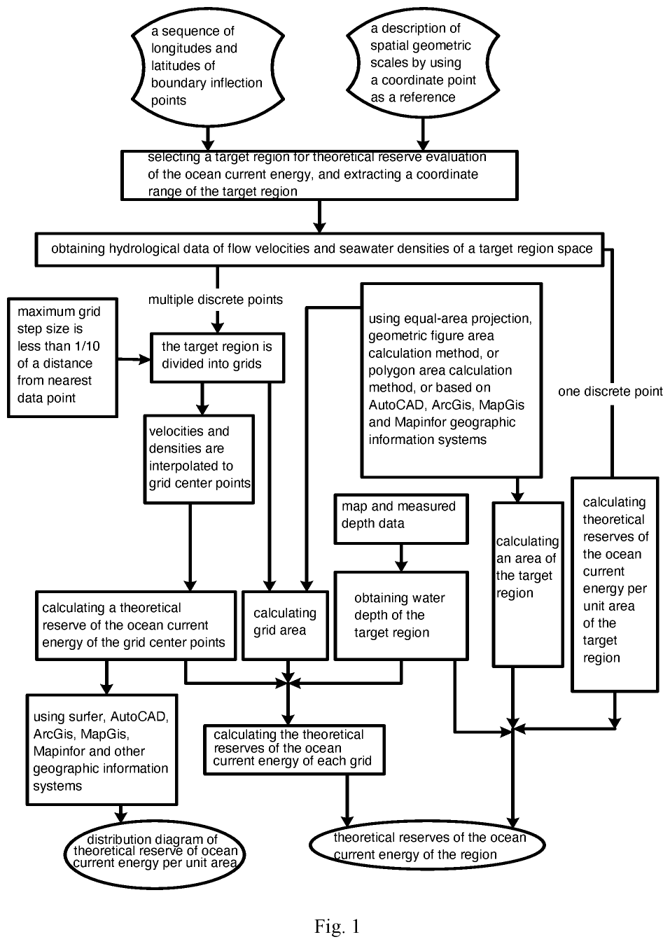

Referring to FIGS. 1-6, A theoretical reserve evaluation method for ocean current energy, comprising steps as follows.

1) Selecting a target region for theoretical reserve evaluation of the ocean current energy, and extracting a coordinate range of the target region;

wherein the coordinate range of the target region is a sequence of longitudes and latitudes of boundary inflection points (or projected plane Cartesian coordinates).

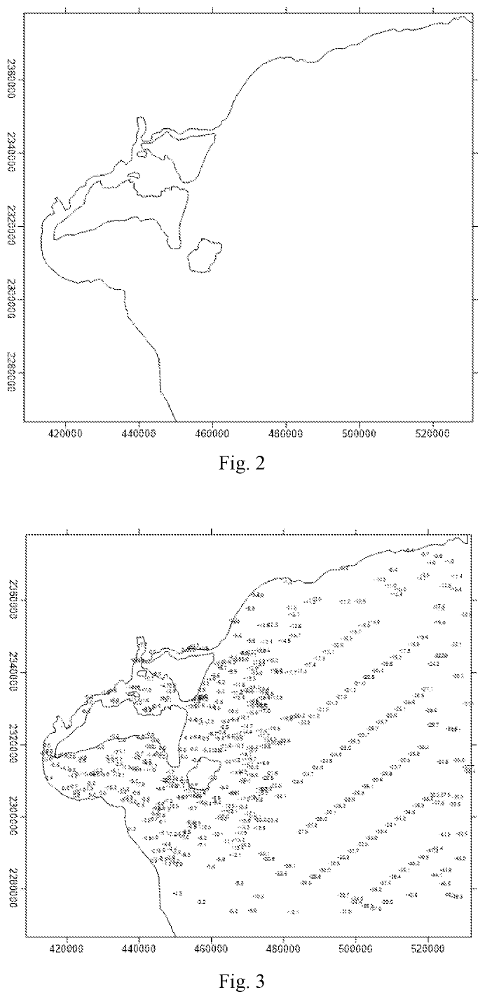

According to this embodiment, Zhanjiang Bay is selected as the target region, and the specific area coordinate range is the sequence of longitudes, latitudes, and identification points of the range coordinate points (or projected plane Cartesian coordinates). Specifically, FIG. 2 is a sketch diagram of selecting the target region according to this embodiment of the present invention, wherein the coordinate range is Cartesian coordinates under UTM49 projection:

| longitude | latitude | description |
|---|---|---|
| 530834.80 | 2375561.11 | boundary inflection point 1 |
| 529889.66 | 2375904.30 | boundary inflection point 2 |
| 529208.04 | 2376643.67 | boundary inflection point 3 |
| 528421.81 | 2377271.27 | boundary inflection point 4 |
| . . . | . . . | . . . |
| 532235.03 | 2272310.26 | boundary inflection point 908 |
| 530834.80 | 2375561.11 | boundary inflection point 1 |

2) Obtaining a seabed water depth of the target region selected in the step 1).

According to this embodiment, the seabed water depth of the target region means seabed water depth within the target region. FIG. 3 illustrates water depth distribution within the selected target region according to this embodiment of the present invention.

3) Obtaining hydrological data of flow velocities and seawater densities of a target region space obtained in the step 2);

wherein the hydrological data of the flow velocities and the seawater densities are measured data at one or more discrete points, or calculated data at one or more discrete points according to a numerical simulation model;

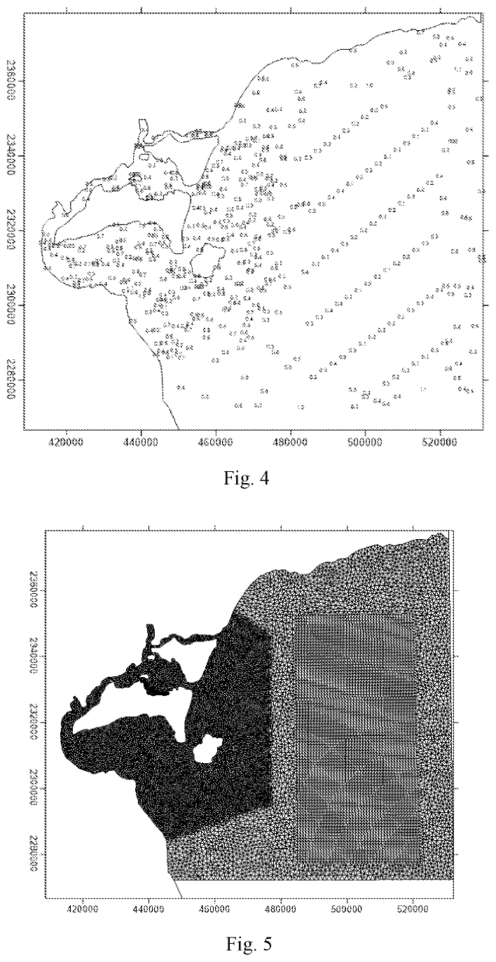

according to this embodiment, the calculation result data of the spatial distribution is obtained by the numerical simulation method, and FIG. 4 illustrates flow velocity data distribution according to this embodiment of the present invention.

After the hydrological data of the flow velocities and the seawater densities at multiple discrete points are obtained, the target region is divided into grids; FIG. 5 is a grid diagram of target region division according to this embodiment of the present invention; a maximum grid step size is less than or equal to 1/10 of a distance from the nearest data point; the hydrological data of the flow velocities and the seawater densities of the discrete points, together with water depth data, are interpolated to grid center points.

In this embodiment, the seawater density is a constant. The seawater density is generally 1.02-1.07 g/cm³, and this embodiment takes 1.05 g/cm³ as the constant.

4) Calculating a theoretical reserve of the ocean current energy per unit area of the target region according to the hydrological data obtained in the step 3);

wherein the theoretical reserve of the ocean current energy per unit area is calculated with the following formula:

E_{D}=∫(½ρV²)dz

wherein: E_{D} is the theoretical reserve of the ocean current energy per unit area, V is the flow velocity, ρ is the seawater density, and dz is the height of vertical space.

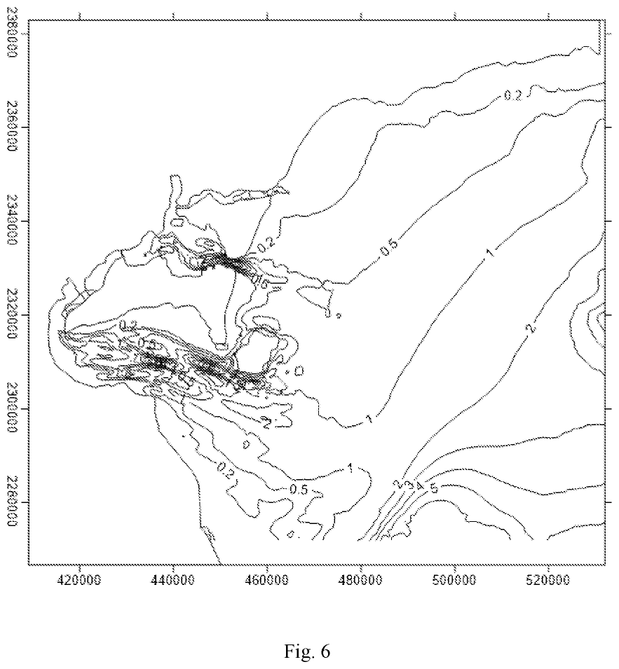

The calculated results can be displayed by using surfer, AutoCAD, ArcGis, MapGis, Mapinfor and other geographic information system software, so as to display a distribution diagram of the theoretical reserves of the ocean current energy per unit area. FIG. 6 is the distribution diagram of the theoretical reserve of the ocean current energy per unit area according to this embodiment of the present invention. The ocean current energy resources are evaluated by the level of the theoretical reserves of the ocean current energy per unit area in the distribution diagram.

5) Calculating an area of the target region;

wherein the area of the target region is calculated based on an equal-area projection, a geometric figure area calculation method, or a polygon area calculation method, or based on AutoCAD, ArcGis, MapGis and Mapinfor geographic information systems;

in order to accurately calculate the theoretical reserves of the ocean current energy in the target region, this embodiment uses the projection of Equal Area to calculate the grid areas of the target region; the calculated grid area gradually increases from 130371 m² to 1054440 m²; by summing up the area of each grid in the target region, the area of the target region is obtained as 8448904058 m².

6) Calculating the theoretical reserves of the ocean current energy within a spatial range of the target region according to the hydrological data of the flow velocities and the seawater densities obtained in the step 3), the seabed water depth of the target region obtained in the step 2), and the area of the target region obtained in the step 5).

The regional ocean current energy theoretical reserve calculating formula is:

E_{R}=∫∫∫(½ρV²)dxdydz

wherein: E_{R} is a regional ocean current energy theoretical reserve, V is a height-related flow velocity; ρ is the seawater density; dz is a step size of a vertical space, which is determined according to the vertical distribution of the hydrological data; ∫∫dxdy is the area of the target region selected for the theoretical reserve evaluation of the ocean current energy; dxdy is a space step size, which is determined by a plane location of the hydrological data and a meteorological complexity of the target region.

According to this embodiment, the theoretical reserve of the ocean current energy in the selected target region, Zhanjiang Bay, is calculated to be 1.01×10¹³ joules.

### Embodiment 2

Referring to FIGS. 1-6, A theoretical reserve evaluation method for ocean current energy, comprising steps as follows.

1) Selecting a target region for theoretical reserve evaluation of the ocean current energy, and extracting a coordinate range of the target region;

wherein the coordinate range of the target region is a description of spatial geometric scales by using a coordinate point as a reference.

In this embodiment, a certain ocean current energy generator is selected as an example: its geographical coordinates are 110.5374° E, 21.08145° N, and the specific regional coordinate range is a circle with a radius of 20 m centered on a base of the ocean current energy generator.

2) Obtaining a seabed water depth of the target region selected in the step 1).

The seabed water depth of the target region in this embodiment is located in a cylindrical space with a height of 30 m.

3) Obtaining hydrological data of flow velocities and seawater densities of a target region space obtained in the step 2);

wherein the hydrological data of the flow velocities and the seawater densities are measured data of one or more discrete points, or calculated data of one or more discrete points according to a numerical simulation method;

according to this embodiment, average measured vertical stratified flow velocity data of a station in 2019 are selected, and specific data are as follows:

| Depth (m) | Velocity (m/s) | Direction (°) |
|---|---|---|
| 2 | 1.65 | 96 |
| 8 | 1.43 | 94 |
| 18 | 1.38 | 88 |
| 28 | 1.25 | 85 |

In this embodiment, the seawater density according to empirical data is 1.05 g/cm³.

4) Calculating a theoretical reserve of the ocean current energy per unit area of the target region according to the hydrological data obtained in the step 3);

wherein the theoretical reserve of the ocean current energy per unit area is calculated with the following formula:

E_{D}=∫(½ρV²)dz

wherein: E_{D} is the theoretical reserve of the ocean current energy per unit area, V is the flow velocity, ρ is the seawater density, and dz is the height of vertical space.

In this embodiment, the obtained vertical stratification of the flow velocities is used for stratification with an intermediate stratification method, and specific layer thicknesses are (5 m, 8 m, 10 m, 7 m), and a water depth of the space in this embodiment is 30 m.

In this embodiment, the theoretical reserves of the ocean current energy per unit area of space in the selected target region are calculated according to the above formula near the ocean current energy generator, and the calculated result is about 31475 joules/m².

5) Calculating an area of the target region;

wherein the target region is a regular cylinder, whose circular bottom has a radius of 20 m. The area is calculated to be 1256 m² according to the geometric figure area (circle area) calculation method.

6) Calculating the theoretical reserves of the ocean current energy within a spatial range of the target region according to the hydrological data of the flow velocities and the seawater densities obtained in the step 3), the seabed water depth of the target region obtained in the step 2), and the area of the target region obtained in the step 5).

The regional ocean current energy theoretical reserve calculating formula is:

E_{R}=∫∫∫(½ρV²)dxdydz

wherein: E_{R} is a regional ocean current energy theoretical reserve, V is a height-related flow velocity; ρ is the seawater density; dz is a step size of a vertical space, which is determined according to the vertical distribution of the hydrological data; ∫∫dxdy is the area of the target region selected for the theoretical reserve evaluation of the ocean current energy; dxdy is a space step size, which is determined by a plane location of the hydrological data and a meteorological complexity of the target region.

In this embodiment, the seawater density according to empirical data is 1.05 g/cm³. The obtained vertical stratification of the flow velocities is used for stratification with an intermediate stratification method, and the specific layer thicknesses are (5 m, 8 m, 10 m, 7 m), and a water depth of the space in this embodiment is 20 m. ∫∫dxdy is the area, which is the area obtained in the step 4).

In this embodiment, the theoretical reserve of the ocean current energy in the selected target region near the ocean current energy generator is calculated according to the above formula. The cylindrical space near the ocean current energy generator has a circular bottom with a radius of 20 m and a depth of 30 m. The theoretical reserve of ocean current energy within such space is 3.95×10⁷ joules.

The above are only preferred embodiments of the present invention, and are not intended to be limiting. Those skilled in the art may make changes and modification according to the technical content disclosed above to obtain equivalent embodiments. However, any simple changes and modifications made to the above embodiments without departing from the content of the technical solutions of the present invention still belong to the protection scope of the present invention.

What is claimed is:

1. A theoretical reserve evaluation method for ocean current energy, comprising steps of:
1) selecting a target region for theoretical reserve evaluation of the ocean current energy, and extracting a coordinate range of the target region;
wherein the coordinate range of the target region is a sequence of longitudes and latitudes of boundary inflection points, or a description of spatial geometric scales by using a coordinate point as a reference;
2) obtaining a seabed water depth of the target region selected in the step 1);
3) obtaining hydrological data of flow velocities and seawater densities of a target region space obtained in the step 2);
wherein the hydrological data of the flow velocities and the seawater densities are measured data at one or more discrete points, or calculated data at one or more discrete points according to a numerical simulation model;
after the hydrological data of the flow velocities and the seawater densities at multiple discrete points are obtained, the target region is divided into grids; a maximum grid step size is less than or equal to 1/10 of a distance from a nearest data point; the hydrological data of the flow velocities and the seawater densities of the discrete points, together with water depth data, are interpolated to grid center points;
4) calculating a theoretical reserve of the ocean current energy per unit area of the target region according to the hydrological data obtained in the step 3);
5) calculating an area of the target region;
wherein the area of the target region is calculated based on an equal-area projection, a geometric figure area calculation method, or a polygon area calculation method, or based on AutoCAD, ArcGis, MapGis and Mapinfor geographic information systems; and
6) calculating the theoretical reserves of the ocean current energy within a spatial range of the target region according to the hydrological data of the flow velocities and the seawater densities obtained in the step 3), the seabed water depth of the target region obtained in the step 2), and the area of the target region obtained in the step 5).

2. The theoretical reserve evaluation method for the ocean current energy, as recited in claim 1, wherein in the step 4), the theoretical reserve of the ocean current energy per unit area is calculated with the following formula:
E_{D}=∫(½ρV²)dz
wherein: E_{D} is the theoretical reserve of the ocean current energy per unit area, V is the flow velocity, ρ is the seawater density, and dz is a height of a vertical space.

3. The theoretical reserve evaluation method for the ocean current energy, as recited in claim 2, wherein in the step 6), the theoretical reserves of the ocean current energy within the spatial range of the target region are calculated according to a regional ocean current energy theoretical reserve calculating formula;
the regional ocean current energy theoretical reserve calculating formula is:
E_{R}=∫∫∫(½ρV²)dxdydz
wherein: E_{R} is a regional ocean current energy theoretical reserve, V is a height-related flow velocity; ρ is the seawater density; dz is a step size of a vertical space, which is determined according to a vertical distribution of the hydrological data; ∫∫dxdy is the area of the target region selected for the theoretical reserve evaluation of the ocean current energy; dxdy is a space step size, which is determined by a plane location of the hydrological data and a meteorological complexity of the target region.
